(19) United States
(12) Patent Application Publication
(10) Pub. No.: US 2004/0019809 A1
(43) Pub. Date: Jan. 29, 2004

(54) System and method for providing entity-based security

(76) Inventors: Joseph Igor Sheinis, Toronto (CA); Daryl Spencer, Toronto (CA)

Correspondence Address: T. Andrew Currier, Lang Michener, 181 Bay Street, Suite 2500, Toronto, ON, M5J 2T7, CA

(21) Appl. No.: 10/200,439

(22) Filed: Jul. 23, 2002

(51) Int. Cl. H04L 9/32

(52) U.S. Cl. 713/202

(57) ABSTRACT

A system and method for providing entity-based security is provided. A set of access control rules are configured and converted to a set of Java classes. Upon receipt of an access request for a data object representing an entity from a client, a proxy interface is provided to the client. The proxy receives an access request for a data object for purposes of enforcing entity-based security. A set of access control rules are checked to determine whether the user has the appropriate access rights for the request.

### FIELD OF THE INVENTION

The present invention relates to a system and method for providing entity-based security. More specifically, the present invention relates to a system and method for providing declarative entity-based security for computer systems.

### BACKGROUND OF THE INVENTION

Java 2 Enterprise Edition™ (J2EE™) Version 1.3, Final Release, by Bill Shannon of Sun Microsystems, Inc., Santa Clara, Calif., dated Jul. 27, 2001, is an enterprise application platform that provides high availability and is reliable, scalable and secure. J2EE applications can be deployed and enhanced as the enterprise responds to its users' needs. J2EE is a product of Sun Microsystems, Inc. of Palo Alto, Calif. and its specifications (“J2EE Specifications”), which can be found on Sun's Website at http://java.sun.com/j2ee/docs.html, are incorporated herein by reference.

The back-end functionality of the J2EE platform is provided by code modules known as Enterprise Java Beans™, or EJBs™. The current Specifications for EJB Version 2.0, Final Release, by Linda G. DeMichiel, L. Unit Yalcinalp and Sanjeev Krishnan of Sun Microsystems, Inc., Santa Clara, Calif., dated Aug. 14, 2001, provide a declarative role-based security model. The EJB Version 2.0 Specifications (“EJB Specification”) can be found on Sun's Website at http://java.sun.com/j2ee/docs.html and are incorporated herein by reference. As more particularly defined in the EJB Specification, an EJB is accessible through the EJB's home interface and/or the EJB's component interface. A client can make access requests to an EJB via the EJB's home interface and/or the EJB's component interface.

Because EJBs are used in enterprise applications, security has always been an important consideration in the development of EJBs. In certain earlier versions of the EJB Specification, security functionality was explicitly programmed in the beans themselves. For example, where access to an EJB was to be restricted, a programmer, such as the Application Component Provider, explicitly programmed any security logic directly in the EJB.

The process of programming security into enterprise applications was simplified in more recent versions of the EJB Specification, which introduced and further defined the deployment descriptor for the EJB java archive (JAR) file. In general terms, the deployment descriptor is an extensible markup language (XML) file, named ejb-jar.xml, that: (a) describes the structure of an EJB and declares the EJB's external dependencies; (b) describes how the EJBs in the JAR are composed into a larger application deployment unit; and (c) allows the configuration of security, or authorization, for an EJB's methods and attributes based on a set of declared security roles. (The XML 1.0 Specifications Recommendations, Second Edition, dated Oct. 6, 2000. XML is an open standard for review by the W3C, and its Specifications, which can be found on the W3C Website at http://www.w3.org/TR/2000/REC-xml-20001006, are incorporated herein by reference). In essence, the deployment descriptor can be used to provide role-based security for EJBs. Overall, recent versions of the EJB Specifications have simplified the programming of security into enterprise applications, but they do not provide a suitable framework for certain scenarios where entity-based security for EJBs is required.

Entity-based security can be required for an entity bean, which is essentially an EJB that represents a set of persistent data maintained in a database for an entity. An entity bean provides an object representation of the data and allows shared access among multiple users. As more particularly defined in the EJB Specification, the data represented by an entity bean, referred to as an entity, can represent any set of related data, typically a record or the result of a query of multiple database tables. For example, in an enterprise application that maintains employee information for a company, an entity bean can represent an employee record for a specific employee.

The need for entity-based security in an enterprise application can arise in a variety of circumstances. For example, entity-based security can be desirable to control access to an entity bean that is the target of a method call (or other type access request). For example, where an entity bean represents employee information for a specific employee it may be desirable to provide an employee with access rights to view the information contained in an entity bean representing his employee information via a method call to the entity bean, but not to provide other employees the same access rights to view the information. Further, it may be desirable to provide a manager of an employee with access rights to methods that create, remove, update, delete and view a number of attributes of an entity bean representing that employee's employee information, but not provide other managers the same access.

Entity-based security can be manually coded for each bean, but this approach can be tedious and time-consuming. Further, where changes are made to the authorization logic, these changes are typically made to a number of EJBs, and therefore the manual coding would typically need to be performed again. Further, an Application Assembler may make changes to EJBs provided by a programmer such as the Application Component Provider, thus increasing time to deployment and the potential for bugs. Still further, a component provider that concentrates on business logic implementation for a specific component could forget or misunderstand the security requirements established for the entire application.

### SUMMARY OF THE INVENTION

In an aspect of the invention, there is provided a method of providing entity-based security in a computer system, comprising the steps of:

receiving a request to access at least one of a plurality of server objects on a server;

determining whether the request is authorized based on a set of access control rules that are respective to an entity represented by the at least one server object;

permitting the request if the request is authorized at the determining step; and,

rejecting the request if the request is not authorized at the determining step.

In a particular implementation of the first aspect, the set of access control rules are configured in a configuration file, such as an XML file.

In a particular implementation of the first aspect, the server is executing Java Enterprise Edition.

In a particular implementation of the first aspect, a set of roles are defined for each of the entities, and the access control rules reflect access rights corresponding to each of the roles. The roles can include an administrator, a viewer and an owner. The access rights can include a right to perform at least one of creating, removing, updating, deleting and viewing the one server object. The set of access control rules can be codified in a set of Java classes and the entity is represented as an entity bean.

In a particular implementation of the first aspect, the request is for a method associated with the server object, or it can be for an attribute associated with the server object.

In a second aspect of the invention, there is provided a method of providing entity-based security in a computer system, comprising the steps of:

intercepting, using a proxy, a request received from a client on behalf of a user;

determining via the proxy whether the request is authorized based on a set of access control rules that are respective to an entity associated with the request;

performing the request via the proxy if the request is authorized; and,

rejecting the request via the proxy if the request is not authorized.

In a particular implementation of the second aspect, the proxy performs the determining step.

In a particular implementation of the second aspect, the determining step comprises the steps of:

deriving a security characteristic associated with the request;

deriving an access right from the security characteristic;

comparing the access right with the access control rules;

providing authorization if the right is validated by one of the access control rules;

denying authorization if the right is not validated by one of the access control rules; and

returning the approval or denial thereof back to the proxy.

In a particular implementation of the second aspect, the security characteristic deriving step is performed by an access manager separate from the proxy;

In a particular implementation of the second aspect, the security characteristic is a user-id and one of the commands of creating, removing, updating, deleting and viewing;

In a particular implementation of the second aspect, the access right deriving step, the comparing step, the approval step and the denial step is performed by the policy manager.

In a particular implementation of the second aspect, the request is directed to a service locator in a Java container, and the service locator use the java.lang.reflect.Proxy class to generate the component proxy.

In a third aspect of the invention, there is provided a method of initiating a container in a J2EE server;

reading an XML security deployment descriptor file containing a set of access control rules;

generating a set of supplementary access control rules from the access control rules; and,

generating an access control manager for utilizing the set of supplementary access control rules to selectively authorize or reject access requests to an object representing an entity.

In a particular implementation of the third aspect, wherein the container is a EJB container.

In a fourth aspect of the invention, there is provided a system for entity-based security comprising a server having a central processing unit (CPU), a data storage device for exchanging non-volatile data with the CPU, random access memory (RAM) for exchanging volatile data with the CPU, and an input device for receiving data for the CPU and output device for presenting outputted data from the CPU. The CPU is operable to receive, via the input device, a request to access one of a plurality of server objects stored in the data storage device, each of the server objects representing an entity. The CPU is also operable to authorize or reject the request based on a set of access control rules that are respective to each of the entities. The CPU is also operable to present the authorization or rejection to the output device. The input device can be any suitable input device, such as a keyboard connected to the server and the output device can be any suitable output device, such as a monitor connected to the server.

In a particular implementation of the fourth aspect, the input device and the output device are combined in a network interface card (NIC) that is connectable to a client machine.

In a particular implementation of the fourth aspect, the set of access control rules are configured in a configuration file, and can be encoded in an XML file.

In a particular implementation of the fourth aspect, the CPU is operable to execute Java Enterprise Edition.

In a particular implementation of the fourth aspect, a set of roles are defined for each of the entities, and the access control rules reflect access rights corresponding to each of the roles. The roles can include an administrator, a viewer and an owner.

In a particular implementation of the fourth aspect, the access rules reflect a right to perform at least one of creating, removing, updating, deleting and viewing the one server object.

In a particular implementation of the fourth aspect, the set of access control rules are codified in a set of Java classes.

In a particular implementation of the fourth aspect, the entity is represented as an entity bean.

In a particular implementation of the fourth aspect, the request is for a method associated with the server object, or the request is for an attribute associated with the server object.

In a fifth aspect of the invention, there is provided a system for providing entity-based security, comprising a server providing a set of application functionality providing access to a number of sets of data representing a number of objects. There is a process executing on the server that is operable to determine whether an access request that is directed at one of the number of sets of data corresponding to one of the number of objects is authorized based on a set of access control rules.

In a particular implementation of the fifth aspect, the set of access control rules are configured in an XML file. The XML file can be used to generate an access control rules object from which the server process obtains the set of access control rules.

In a particular implementation of the fifth aspect, the server executes Java Enterprise Edition.

In a particular implementation of the fifth aspect, the number of sets of data are represented by a number of entity beans.

In a particular implementation of the fifth aspect, there is additionally provided a database for storing a set of user access rights for the number of sets of data.

In a sixth aspect of the invention, there is provided a method of providing entity-based security in a computer system, comprising the steps of: configuring in a configuration file a set of rules for controlling access to a set of data objects; generating a set of access control code for one of the set of data objects based on the set of rules; and, injecting the set of access control code into the one of the set of data objects.

### BRIEF DESCRIPTION OF THE DRAWINGS

The present invention will now be described, by way of example only, with reference to certain embodiments of the invention and the attached Figures, in which:

FIG. 1 shows a system for implementing declarative entity-based security comprising a number of client machines connecting to a server in accordance with an embodiment of the invention;

FIG. 2 shows a schematic representation of various software and hardware components implemented on the system shown in FIG. 1;

FIG. 3 shows a flow chart of a method of providing entity-based security in accordance with an embodiment of the invention;

FIG. 4 shows a flow chart of a method of authorizing an action providing entity-based security in accordance with an embodiment of the invention;

FIG. 5 is an exemplary organizational chart demonstrating a number of users of a system upon which entity-based security can be enforced in accordance with the invention;

FIG. 6 is a table of salaries for each employee in FIG. 5;

FIG. 7 is a table of access rights to the Employee Record of each employee in FIG. 5;

FIG. 8 shows a flow chart of the method of providing entity-based security in accordance with and embodiment the invention; and

FIG. 9 shows a flow chart of a method of providing entity-based security in accordance with an embodiment of the invention.

### DETAILED DESCRIPTION OF THE INVENTION

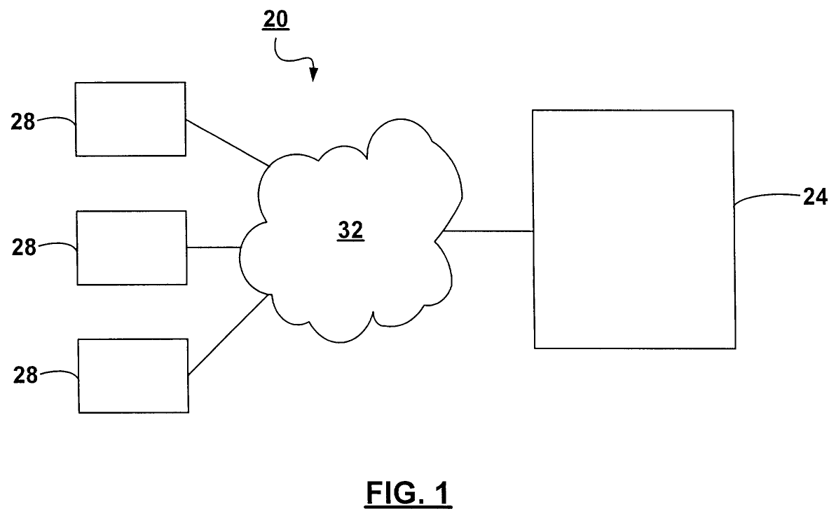

A system in accordance with an embodiment of the invention is generally shown at 20 in FIG. 1. System 20 is comprised of a server 24 and a number of client machines 28 connected to server 24 via a communication medium 32. Server 24 is any server known in the art, such as the Sun Enterprise 10440 Server, sold by Sun Microsystems of Palo Alto, Calif., and generally includes a central processing unit, random access memory, data storage means, and a computer network interface to allow server 24 to communicate over communication medium 32. In an embodiment of the invention, server 24 is generally operable to function as a J2EE-based network computing server.

Client machine 28 is any computing device known in the art, (such as personal computers, network thin client machines, mobile phones, personal digital assistants, etc.) that have a basic set of hardware resources, such as a central processing unit, random access memory, input/output functionality so that it is generally operable to act as a client machine to server 24. Communication medium 32 can be any suitable network, such as the Internet or the like. In a particular embodiment, communication medium 32 is the Internet.

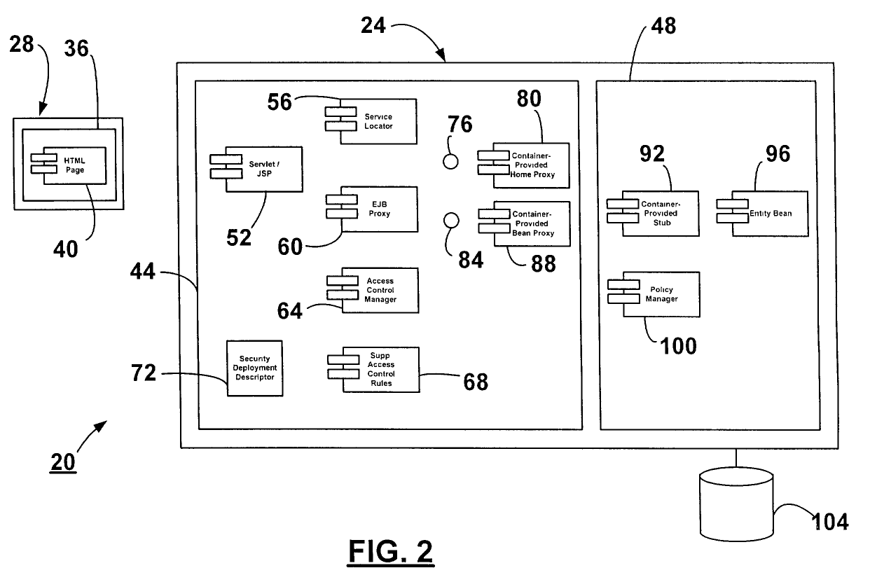

FIG. 2 shows a number of software and hardware components implemented on the system shown in FIG. 1. Thus, as shown in FIG. 2, client machine 28 comprises a Web browser 36 that enables interaction with a series of hypertext markup language (HTML) pages 40.

As shown in FIG. 2, server 24 comprises a Web container 44 and an EJB container 48. As more particularly defined in the EJB Specification, Web container 44 and EJB container 48 are collections of components and objects that provide predetermined functionality for server 24. Both Web container 44 and EJB container 48 can be executed in a single Java Virtual Machine (JVM) or can be segregated into separate JVMs, on separate physical machines, or can individually be distributed across more than one machine.

In a particular embodiment, Web container 44 hosts a one or more Java servlets 52 and/or Java Server Pages (JSPs) (not shown). In the present embodiment, it is assumed that web container 44 only hosts a single servlet 52, but typically container 52 hosts a plurality of servlets and/or JSPs. Servlet 52 executing in Web container 44 is an application that extends the functionality of a Web server (also not shown), enabling access to data in EJB container 48 via browser 36.

Web container 44 is also comprised of a service locator component 56, an EJB proxy 60, an access control manager 64, a set of Java class-based access rules 68 and a security deployment descriptor file 72.

Service locator 56 is analogous to a DNS lookup for Internet addresses in that service locator 56 allows the use of user-friendly aliases for home interfaces and component interfaces that are available for access on system 20. Upon receipt of a request for a home interface or a component interface using such a user-friendly alias, service locator 56 looks up the alias in a table and determines the identity of the interface respective to the user-friendly alias.

EJB proxy 60 is dynamically generated using any suitable means to generate a proxy, such as the java.lang.reflect.Proxy class. EJB proxy 60 is generated in response to a request to service locator 56 for a home interface or a component interface using the user-friendly alias for that component. In particular, when servlet 52 requests a home interface from service locator 56 (such as home interface 76 in FIG. 2), an EJB proxy 60 is dynamically generated to provide a transparent supra-interface for servlet 52, through which servlet 52 can access home interface 76. In this fashion, direct access to home interface 76 is not allowed and EJB proxy 60 is able to control all access thereto. Service locator 56 thus wraps home interface 76 in EJB proxy 60, providing transparent access to home interface 76 to servlet 52 via EJB proxy 60. An additional EJB proxy 60 can be generated and likewise used to provide transparent access to other interfaces, such as component interface 84.

The primary task of access control manager 64 is to authorize or reject calls or access requests made on a home interface 76 (via its respective EJB proxy 60) and/or a component interface 84 (via its respective EJB proxy 60), the details of which will be discussed in greater detail below. (As used herein, the term “call” has substantially the same meaning as the term “access request”, and the terms are used substantially interchangeably according to the context in which they are used.) In the present embodiment, access control manager 64 is a component that is separate from EJB proxy 60 (or EJB proxies 60), but in other embodiments of the invention it is to be understood that the functionality provided by access control manager 64 can be incorporated directly into EJB proxy 60.

As previously mentioned, Web container 44 contains a home interface 76, which is an interface for a container-provided home proxy 80. Web container 44 also contains a component interface 84, which is an interface for a container-provided bean proxy 88. Container-provided home proxy 80 and container-provided bean proxy 88 provide functionality locally in Web container 44 to access an entity bean 96 in EJB container 48. (Other container-provided home proxies and container-provided bean proxies can be included in container 44, as desired.)

Security deployment descriptor 72 is an XML file similar to the standard deployment descriptor (not shown) associated with container 44, in that each one contains a set of rules for controlling access to a set of EJBs in EJB container 48 and, accordingly, any data contained in entity bean 96. However, while container 44's standard deployment descriptor provides, among other things, a set of access control rules that can allow for role-based security, container 44's standard deployment descriptor does not allow for the entity-based security that is in part provided by security deployment descriptor 72.

Security deployment descriptor 72, thus, allows for the declarative specification of a set of access control rules that are at least partially entity-based for entity bean 96 (or a plurality thereof) contained in EJB container 48. Entity-based security is achieved by a set of tags similar to those employed to provide role-based security capabilities to the standard deployment descriptor of Web container 44.

In the present embodiment, the access control rules of security deployment descriptor 72 are positively declared and are selected from a combination of entity-based and role-based requirements. That is, the authorization criteria to be met are stated in terms of the criteria for authorized groups. For example, where an entity bean represents an employee's information for an employee, and where only an employee's manager can modify the employee's information, the access control rule can be stated as “can access the entity bean with the role of administrator”. For example, roles can include “owner”, “administrator” and “viewer” where an “owner” can create, remove, update, delete and view any information of an entity, an “administrator” can update and view the information of an entity and a “viewer” can only view the information of an entity. The roles, however, can be defined as required and can have different access rights for different entities. Further, users can be assigned different roles for different entities.

In other embodiments, it will now be apparent to those of skill in the art that a number of different means can be employed to declare the access control rules, other than through a security deployment descriptor 72. Further, while security deployment descriptor 72 in the embodiment is an XML file, it is understood by those of skill in the art that the same functionality can be provided by other means, including files written in other mark-up languages, objects capturing the access control rules as attributes and a set of one or more database tables.

Upon execution of Web container 44, a set of supplementary access control rules 68 are generated from the access control rules codified in security deployment descriptor 72 and are encapsulated in a set of Java classes that remain resident in memory for the duration of the execution, the details of which will be discussed in greater detail below.

EJB container 48 represents an application or set of applications that provide a set of functionality to web container 44. The functionality of the applications is provided by one or more EJBs. The functionality of the applications is provided by one or more EJBs, as implemented by Java classes.

EJB container 48 has a container-provided stub 92 for channeling calls directed at a particular entity bean 96 from a set of one or more entity beans 96 in EJB container 48. Entity beans 96 are comprised of a set of Java classes that can include a number of methods and attributes that are accessible via home interface 76 and component interface 84, via stub 92.

EJB container 48 also contains a policy manager 100 that is responsible for determining access rights of a particular user logged-in to system 20, and who is generating a particular access request. Policy manager 100 is implemented as a stateless session bean, and as such can obtain logged-in user information portion of the security characteristics of any given call from the session context, as provided by EJB container 48. In turn, these access rights are used, (in conjunction with the access rules in supplementary access control rules 68), to determine whether a particular access request is authorized.

In the present embodiment, policy manager 100 is a set of Java classes in EJB container 48 with one or more methods providing the logic and functionality that are employed to determine the access rights of an access request for target EJB 96 on behalf of a logged-in user. By placing this functionality in EJB container 48, security is offered for non-Web-based clients, such as remote method invocation clients, Internet Inter-ORB protocol clients, Web services clients or message-based clients. Further, by placing policy manager 100 in EJB container 48, security is checked in the same JVM where the entity is located, increasing the performance and scalability of the security services. In other embodiments, however, it can be desired to place policy manager 100 in another Java container, such as Web container 44.

A database 104 is shown connected to server 24. Database 104 can be any one of a number of products and/or implementations for maintaining relational data. (In other embodiments, database 104 can be any other type of means for maintaining persistent information storage, such as products or implementations for hierarchical or object-oriented databases.) In a particular embodiment of the invention, database 104 is run on a database server executed on a separate computer, such as Microsoft SQL Server or Oracle 8i. Server 24 is in communication with database 104 via a suitable protocol such as the Java database connectivity (JDBC) protocol. While database 104 is shown as being external to server 24, it will be understood by those of skill in the art that database 104 can reside on server 24, and can even reside within the same JVM as EJB container 48.

Database 104 stores user account information and persistent data for use with the application functionality of EJB container 48. In particular, database 104 includes information that is represented within one or more entity beans 96. Further, database 104 stores access rights about which entities, as represented within one or more entity beans 96, a user can access and with what role.

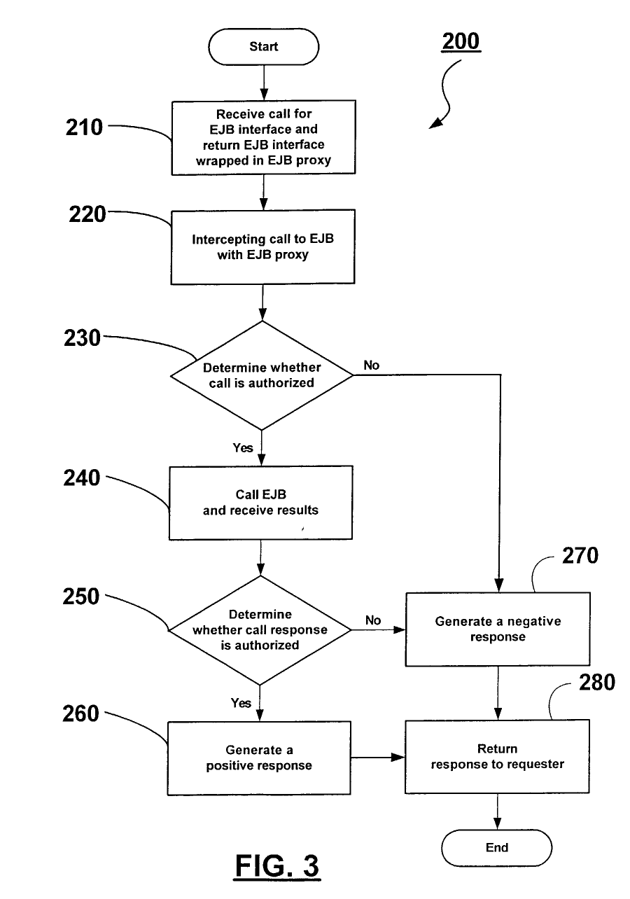

Referring now to FIG. 3, a method for providing entity-based security will now be explained. In order to assist in the understanding of the method in FIG. 3, and to provide further understanding of system 20, the explanation of the method shown in FIG. 3 will be discussed with reference to the embodiment shown as system 20 in FIGS. 1 and 2. (It is to be understood that the method of FIG. 3 can be implemented on other systems, however, and that system 20 can be operated in different ways.)

Referring first to step 210, a call directed at a particular entity bean 96 is received. In the particular embodiment shown in FIG. 2, Web browser 36 running on client machine 28 requests an HTML page 40. This request is addressed to server 24 which, in turn, directs the request to servlet 52. Servlet 52 can request information by requesting either home interface 76 or component interface 84 of entity bean 96 and making calls via these interfaces. Servlet 52 initiates communication with entity bean 96 by making a call to service locator 56 for home interface 76. Where servlet 52 is already in communication with home interface 76 of entity bean 96 through EJB proxy 60, servlet 52 can call component interface 84 of entity bean 96. Where servlet 52 makes a call requesting an interface of an EJB, the call is directed through service locator 56. In this way, no actual EJB interface is provided directly to servlet 52, thus ensuring that authorization security is enforced. For purposes of illustration, it will be assumed that servlet 52 is initiating communication with entity bean 96 at this point.

Upon receipt of a call for home interface 76 respective to entity bean 96, service locator 56 generates an instance of home interface 76 of container-provided home proxy 80 of entity bean 96. As previously discussed, service locator 56 is analogous to a DNS lookup for Internet addresses in that service locator 56 allows the use of user-friendly aliases. Thusly, service locator 56 provides EJB proxy 60 as a substitute for home interface 76 using a local service locator pattern implementation in Web container 44. EJB proxy 60 implements the same interface as home interface 76 and thus appears to servlet 52 the same as home interface 76 for container-provided home proxy 80. Container-provided home proxy 80 serves as an interface for the home interface of entity bean 96 that resides in EJB container 48. (Where a call is received for a component interface 84 respective to entity bean 96, the foregoing can be suitably modified to provide an EJB proxy 60 respective to component interface 84, to thereby provide servlet 52 with transparent access to component interface 84. Furthermore, it is also possible that a call is being made at step 210 wherein an EJB proxy 60 has already been created in response to a previous call on the same home interface 76 or component interface 84, in which case the relevant EJB proxy 60 need not be recreated.)

At step 220, a call from servlet 52 to entity bean 96 is intercepted by EJB proxy 60. As service locator 56 returned EJB proxy 60 to servlet 52 upon request for home interface 76, servlet 52 communicates with EJB proxy 60 as it would have with home interface 76.

At step 230, it is determined whether the call on home interface 76 is authorized. In the present embodiment, EJB proxy 60 handles the determination as to whether the call is authorized for a user upon whose behalf the call was made. EJB Proxy 60 extracts security characteristics from the call in order to make the determination. The security characteristics can include any number particular attributes of the call, including, but not limited to: a) the type of call that is made; b) the identity of the logged-in user on whose behalf the call was made, (“principal”), which can be extracted by obtaining state information maintained from the time that the user logged in.

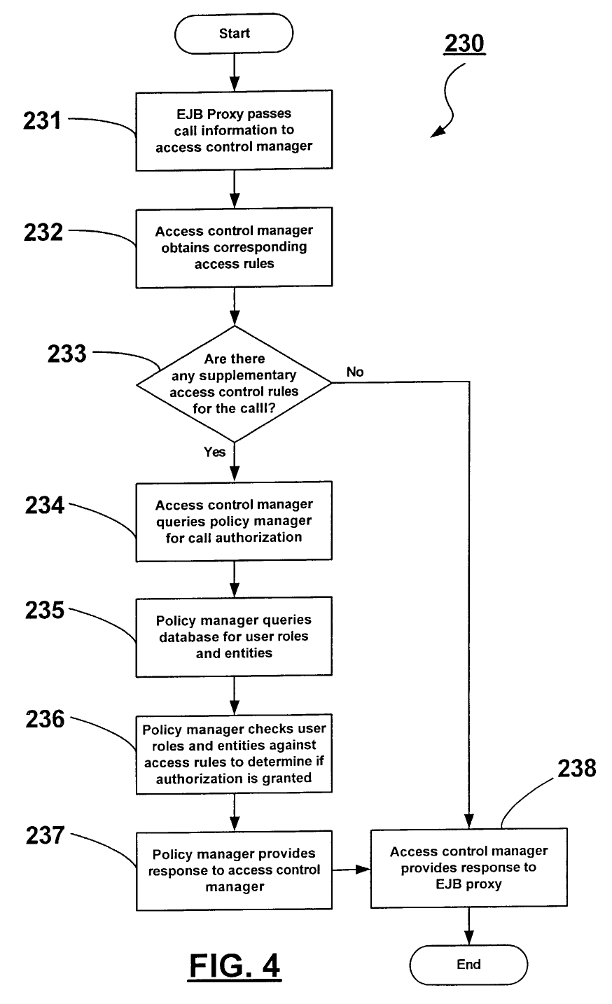

As best seen in FIG. 4, a method of performing the determination at step 230 in accordance with an embodiment of the invention is shown. At step 231, EJB proxy 60 provides the security characteristics to an access control manager 64.

At step 232, access control manager 64 obtains any access rules relevant to the security characteristics that were received at step 231. In the present embodiment, access control manager 64 obtains access rules from supplementary access control rules 68 for any rules specific to the call made by servlet 52. The types of rules are not specifically limited, and there are any number and combination of security characteristics of a call to entity bean 96 for which access control that is at least partially entity-based can be based

At step 233, access control manager 64 examines the access control rules obtained at step 231 and makes an initial determination as to whether to approve or reject the call. This initial determination can be made in a variety of ways. In a present embodiment, it is assumed that system 20 follows the bureaucratic rule “if a call is not explicitly allowed, then it is forbidden”. Accordingly, the initial determination at step 233 is made by examining the access control rules obtained at step 232 and comparing those rules with the relevant security characteristics of the call obtained at step 231. For example, if there is an access control rule that states “allow call of type ‘A’ for everyone”, and the type of call that was received at step 210 was a call of type ‘A’, then at step 233 an initial determination will be made that “Yes” the call is approved, and the identity portion of the security characteristics can be ignored. At this point, the method advances to step 238, at which point the call is “approved”, and such approval is passed back to step 230 on FIG. 3.

However, if, at step 232, there is an access control rule that states “allow call of type ‘B’ for only certain people”, and the type of call that was received at step 210 was a call of type ‘B’, then at step 233 an initial determination will be made that “No” the call is not approved, and the identity portion of the security characteristics will be deemed relevant, and the method will advance to step 234 so that a further determination as to whether to approve or reject the call can be made.

At step 234, access control manager 64 queries policy manager 100 for authorization to make the call. In a present embodiment, the user information from the security characteristics of the call is obtained by policy manager 100 as part of the overall the session context that is provided by the EJB container 48. (In another embodiment of the invention, presently less preferred, it is possible for access control manager 64 to directly pass security characteristics of the call to policy manager 100, including the identity of the logged-in user on whose behalf the call was made.)

At step 235, policy manager 100 queries database 104 whether the logged-in user has access rights to entity bean 96 and with what roles. In the present embodiment, the primary function of policy manager 100 is to determine the authorization of the call, given the subset of supplementary access control rules 68 pertinent to the call provided by access control manager 64, and the identity of the logged-in user on whose behalf the call was made. Policy manager 100 queries external database 80 via JDBC or any other suitable means. In a present embodiment, database 104 can maintain role and entity access information for all users of system 20 in a table, but it is to be understood by those of skill in the art that this information can be maintained in a variety of other ways. Database 104 returns to policy manager 100 whether the logged-in user can access the entity represented by entity bean 96 and with what roles. Those of skill in the art will now recognize, however, that step 235 can be streamlined by having policy manager 100 keep a cache of the data in external database 80, rather than accessing external database 80 each time policy manager 100 needs to make an authorization determination.

At step 236, policy manager 100 then verifies that the logged-in user has access to entity bean 96, and then proceeds to compare the roles with which the logged-in user can access the entity, with each set of authorization criteria for the supplementary access control rules 68 received at step 232. In a particular embodiment, the authorization criteria are positively declared and, upon satisfaction of any of the sets of authorization criteria, the matching process is terminated. If the user's information satisfies the authorization criteria, policy manager 100 determines that the call is authorized. Where the user's information does not satisfy the authorization criteria, policy manager 100 determines that the call is not authorized (i.e. rejected.)

At step 237, policy manager 100 responds as to whether the call is authorized to access control manager 64, by passing the authorization or rejection result determined at step 236. The method then advances from step 237 to step 238, and the “authorization” or “rejection” response is provided to EJB proxy 60. The method in FIG. 4 at step 238 then returns this “authorization” or “rejection” determination back to step 230 in FIG. 3.

While the method in FIG. 4 reflects a specific embodiment of the invention, it is to be understood by those of skill in the art that other methods of authorizing the call can be used.

Referring again to FIG. 3, if the response received by EJB proxy 60 at step 230 is negative (i.e. a “rejection” received from step 238 in FIG. 4), then the method advances to step 270. At step 270, EJB proxy 60 generates a negative response, rejecting the call. In a particular embodiment of the invention, EJB proxy 60 generates an exception. EJB proxy 60 then returns the negative response to the requester, servlet 52, at step 280.

If however, the response received by EJB proxy 60 at step 230 is positive (i.e. an “authorization” received from step 238 in FIG. 4), the method advances to step 240 where EJB proxy 60 proceeds to make the call to entity bean 96. Such a call is made via EJB proxy 60 in the usual manner, as will be appreciated by those of skill in the art. For example, this call can either be directed to container-provided home proxy 80 via home interface 76 or to container-provided bean proxy 88 via component interface 84, depending on the particular type of call that was made at step 210. For example, where the type of call at step 210 was an initiation of communication with entity bean 96, then at step 240 EJB proxy 60 makes a call on home interface 76 of container-provided home proxy 80 of entity bean 96 at step 240. As another example, where the type of call made at step 210 was a request for component interface 84 of container-provided bean proxy 88, then at step 240 service locator 56 generates an instance of component interface 84 of container-provided bean proxy 88 and wraps it in a newly generated instance of EJB proxy 60 before returning bean proxy 88. Other types of call completions at step 240 will occur to those of skill in the art.

At step 250, a determination is made as to whether the response to the call made at step 240 is authorized. In the present embodiment, this determination at step 250 is performed in substantially the same manner as the determination made at step 230, except that this time it is the delivery of the response to the call for which the determination is made, rather than a determination as to the authorization of the call itself. In essence, EJB proxy 60 then repeats the process of providing entity-based security on the response received at step 240, except that entity-based security is enforced for the returned response, instead of the placed call.

It is contemplated that performance of step 250 can be omitted in other embodiments, but is included in the present embodiment for situations where entity-based security is desired for responses. For example, where the results returned include a collection of objects representing data from one or more entities, it can be desired to verify that a client is authorized to access each object in the collection upon receipt of the collection by EJB proxy 60. Access to each of the objects in the collection can be authorized before the response is provided to servlet 52.

Where, at step 250, servlet 52 is determined to be unauthorized to receive the response, the method advances to step 270, at which point, EJB proxy 60 generates a negative response and returns the negative response to servlet 52 at step 280. In a present embodiment of the invention, at step 280 EJB proxy 60 generates an exception and returns it to servlet 52.

If, however, at step 250 servlet 250 is determined to be authorized to receive the response, the method advances to step 260, at which point EJB proxy 60 generates a positive response at step 260, and the positive response is returned to servlet 52 at step 280. In a present embodiment, the positive response is comprised of the call response received from entity bean 96 by EJB proxy 60. Thus, at step 280, EJB proxy 60 then provides the positive response generated at step 260 to servlet 52.

The method then advances from step 280 to the “End”. If another call is to be made, the method starts anew at step 210.

While the foregoing discussion of system 20, and the methods in FIGS. 3 and 4 are directed to specific implementations of the invention, it will be understood that combinations, sub-sets and variations of these embodiments are within the scope of the invention. For example, those of skill in the art will appreciate that, servlet 52 handles responses received at step 280 in the usual manner, such as passing the information from the response to a JSP for generation of a new HTML page 40 to return to client machine 28. HTML page 40 generated by the JSP is dynamic and reflects the results of the authorization check. Where EJB proxy 60 generated a positive response at step 260, HTML page 40 returned to client machine 28 can display information requested on a previously viewed HTML page 40. Where EJB proxy 60 generated a negative response at step 260, HTML page 40 can display a message that the user logged-in to client machine 28 does not possess the appropriate authority to access the requested information.

It will now be appreciated by those of skill in the art that the foregoing embodiments can be used in order to implement entity-based security for system 20, and can be used to implement fine-grained security over a number of aspects and/or types of calls from serviet 52 to bean 96 using the methods of FIGS. 3 and 4.

Since entity beans correspond to persistent entities that could be accessed by multiple client machines 28, simple entity-based security could be provided for a specific entity bean instance. Whenever a client calls a method on a component interface of an entity bean, the system could verify that the user on whose behalf the call is made has the appropriate authority to access this entity.

The entity security check for a call for a method of a component interface of an entity bean is typically performed before the EJB method call. The ability to perform an entity access check after a method call on a home or component interface also could be desirable in some situations. For example, if a method call could change the entity in a way that it would become inaccessible to the client, the security check after the method call can ensure that the entity is still accessible. If a security check after the method call fails, the client will receive a security exception and the transaction will be rolled back, but if this method performed a separate transaction or had other side effects, such side effects may remain.

Another form of entity-based security is the ability to check if a logged-in user can access one or more arguments of an EJB method, whether on the entity or session bean and whether on the home or component interface. Since the method arguments could represent controlled entities, such as component interfaces of other entity beans or instances of value classes, they may require access control.

Access control to a EJB method's arguments can be determined before the method is called, but it can be checked after the method call to ensure that the method call did not change the argument accessibility for a user on whose behalf the method call was made.

In a similar manner, it can be desirable for the system to control access at least partially based on a user's entity to the result of any method on the home or component interface of an entity or session bean, if the method result represents a controlled entity. In this case, it is efficient to check after the method has been called.

For example, this approach could be employed for the “create” method of the entity bean's home interface to ensure that the user represented by the call has access to the entities he created.

Another scenario where entity-based security may be used is where an EJB method result is a collection of entity bean component references. Such a collection can be returned in response to an access request that includes the findXXX or selectXXX methods on the EJB home interface and by the getXXX methods for the container-managed one-to-many or many-to-many relationships on the entity bean local component interfaces.

Similarly, the setXXX methods for container-manager relationship (CMR) fields take a collection of entities as a parameter. In such cases, entity-based access could be controlled for every entity in the collection.

It can be desired to control what entities a client can add or remove via the CMR field. A getXXX method for the CMR field that returns a collection could be exposed in the local interface of the entity bean. Once a client has obtained this CMR collection, it could modify the collection by adding and removing references to it. After the transaction is committed, these references will become persistent.

Entity beans are removed by the “remove” method call on the bean's home interface. The removal of the entity is not available neither as a method target, nor as a method parameter or result. Entity-based security can, however, be quite important to ensure that the client is authorized to remove the entity. This security check can be performed by finding the entity corresponding to the parameter passed to the remove method (either the primary key or handle), and check the client's authority before performing the “remove” method.

The foregoing cases describe different examples of different types of entity-based security. Supplementary security that can include entity-based rules can be enforced independent of, or in addition to, the regular J2EE role-based security. In some cases, however, these two access control methods are not orthogonal; that is, a client could have a “modify” access to some instances of a given entity bean, but only “view” to other instances of it. In such cases, it may be desirable to combine both entity-based and role-based security. Using the present invention, entity-based access rules can be listed alongside the role-based access rules.

In another embodiment of the invention, the supplementary access control rules are declared in security deployment descriptor 72, similar to the manner in which role-based access rules are declared in the container's deployment descriptor. A set of tags are defined allowing an Application Assembler or other programmer to configure entity-based security for: a) home interface and component interface methods of session and entity beans, b) the results of these methods, c) collections of entity bean references, and d) references added and removed to the CMR collection filed and the removal of entity beans.

An example of a set of tags used to declare the access control in security deployment descriptor 72 that reflect a specific exemplary implementation of system 20 of the embodiments shown in FIGS. 1 and 2 is included in Appendix 1.

For purposes of illustration of the above-noted embodiment, a specific scenario will now be discussed, that reflects a specific exemplary implementation using system 20 and the method in FIG. 2. The users of system 20 are employees of a fictitious company and a particular application provided by the EJB container is an employee information system, in which employee information is accessed through instances of the EmployeeRecord entity bean.

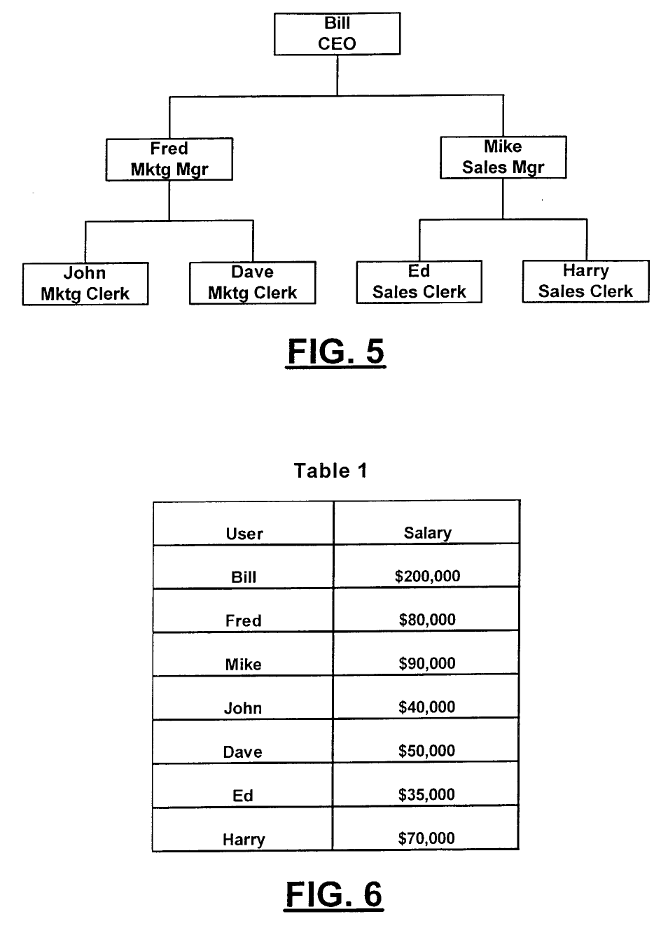

An organizational chart for this fictitious company is shown in FIG. 5. The chart shows seven employees of the company occupying various positions in three separate departments.

Bill is the Chief Executive Officer (CEO) and oversees the operation of the Marketing department, of which Fred is the manager, and the Sales department, of which Mike is the manager. John and Dave are two Marketing clerks who report to Fred, and, likewise, Ed and Harry are two Sales clerks who report to Mike.

FIG. 6 shows a table of employees and their salaries that are maintained in database 104.

For this particular example, it is desired to provide the following access controls or access rights:

an employee can “view” his own current annual salary

a manager can “create”, “view”, “modify” or “delete” the salary of any other employee in his department

an executive can “create”, “view”, “modify” or “delete” the salary of any employee

Two roles, “viewer” and “administrator”, are created for purposes of the EmployeeRecord entity beans that correspond to the records of Table 1 in FIG. 6. A “viewer” is permitted to call a method named viewSalary( ) that allows him to view a salary contained in an EmployeeRecord entity bean and an “administrator” is permitted to call methods called createSalary( ), viewSalary( ), updateSalary( ) and removeSalary( ) that allow him to create, view, modify and delete an extension contained in an EmployeeRecord entity bean. An employee who is not permitted to access a specific EmployeeRecord entity bean 96 is not provided access to that bean, nor is he assigned a role for it. These security rules can be rewritten using high-level pseudo-code as follows:

the user could view a salary via the viewSalary( ) method if he could access the EmployeeRecord entity bean with the “viewer” role

the user could create, view, update or delete a salary via the createSalary( ), viewSalary( ), updateSalary or deleteSalary( ) if he could access the EmployeeRecord entity bean using the “administrator” role

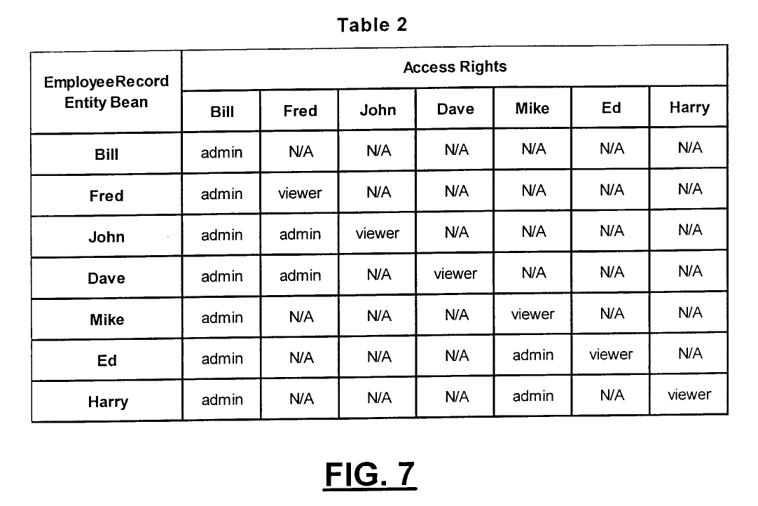

FIG. 7 is a table of the EmployeeRecord entity beans for each employee and the access rights, if any, provided to each employee. As Bill is an executive, he has the ability to create, view, update and delete salaries of any EmployeeRecord entity bean. As Fred is a manager of the Marketing department, he has the ability to create, view, update and delete salaries of the EmployeeRecord entity beans of employees in the Marketing department, excluding himself. Likewise, Mike as the Sales manager has the ability to create, view, update and delete salaries of the EmployeeRecord entity beans of employees in the Sales department, excluding himself. Each of John, Date, Ed and Harry have the ability to view their own current annual salaries via the EmployeeRecord entity bean.

Data for an employee is maintained by database 104 and accessed through an entity bean called EmployeeRecord of which an instance is generated upon receipt of an access request. In generating an instance, EJB container 48 queries database 104 for an employee's information that is then encapsulated in entity bean 96. In this scenario, servlet 52 provides users the ability to create, view, update and delete the salary of an employee.

The configuration code provided in Appendix 2 is generated from this pseudo-code and placed in the entity-based security descriptor.

Security deployment descriptor 72 is then converted into security java classes that are encapsulated in supplementary access control rules 68 during application deployment in Web container 44.

When John wishes to look up his current annual salary, John opens browser 36 and selects the uniform resource locator (URL) associated with servlet 52 executing on server 24. John then logs in on an HTML page generated by servlet that is served to browser 36. Upon receipt of a valid login ID and password and upon selection of a hyperlink to a page providing employee information application functionality, servlet 52 serves browser 36 an HTML page 40 that allows John to select a user and an action to view his own information. Upon John's selection of this option, browser 36 sends a request to servlet 52 specifying the requested user and action. In a first instance, John requests to view his salary. Upon receipt of this request, servlet 52 calls home interface 76 of container-provided home proxy 80 that accesses the home interface of entity bean 96 located in EJB container 48.

Service locator 56 receives this call for home interface 76 of entity bean 96. In the same manner as noted previously, service locator 56 generates an instance of home interface 76 and container-provided home proxy 80. Service locator 56 then wraps home interface 76 with a newly generated instance of EJB proxy 60 and returns it to servlet 52. Servlet 52 then requests access to entity bean 96 through which the employee data of John is accessed.

This call for entity bean 96 is intercepted by EJB proxy 60. Upon receipt of this request, EJB proxy 60 sends a request to service locator 56 for entity bean 96. Service locator 56, in turn, requests EJB container 48 to generate an instance of entity bean 96 containing John's employee data. EJB container 48 queries database 104 and obtains John's employee data information and encapsulates it in a newly generated instance of entity bean 96. EJB container 48 then directs Web container 44 to generate an instance of this bean, container-provided bean proxy 88.

At step 210, service locator 56 then wraps component interface 84 of container-provided bean proxy 88 in a newly generated instance of EJB proxy 60 and returns it to servlet 52. In this example, there are no access controls on the request for component interface 84 and, as such, no access control checks are performed thus far.

Servlet 52 then calls the viewSalary( ) method on entity bean 96. At step 220, EJB proxy 60 intercepts this call.

At step 230, EJB proxy 60 determines whether the viewSalary( ) method call is allowed. At step 231, EJB proxy 60 passes information about the call to access control manager 64. Access control manager 64 then obtains the set of rules associated with this call from supplementary access control rules 68 at step 232. In this case, access control manager 64 is provided the following criterion which must be satisfied for this call to be authorized: the logged-in user (in this case, John) can access John's EmployeeRecord entity with the role of “viewer” or “administrator”.

At step 233, access control manager 64 determines that there are relevant access controls for this call. At step 234, access control manager 64 then queries policy manager 100, providing the criterion obtained in step 232 and security characteristics, including the “principal”, or identifier associated with the login ID for the user of the client.

Upon receipt of this query from access control manager 64, at step 235, policy manager 100 queries database 104. In this case, each employee's access rights for each of the seven employees' EmployeeRecord entity bean are stored in a user database presented in Table 2 of FIG. 7. Policy manager 100 determines that John has the role of “viewer” for his own EmployeeRecord entity bean.

Policy manager 100 then compares the security characteristics with the access rules provided. In this case, as John has the role of “viewer” for the requested EmployeeRecord entity bean, policy manager 100 determines that this call is authorized.

At step 236, policy manager 100 then returns this affirmative response to access control manager 64 which, in turn, provides it to EJB proxy 60.

At step 240, EJB proxy 60 calls the business method viewSalary( EmployeeRecord ), which accesses John's EmployeeRecord entity bean 96.

Upon receipt of a response from entity bean 96, component proxy 84 passes it to EJB proxy 60. At step 250, EJB proxy 60 queries access control manager 64 to determine if the response provided is authorized for return to servlet 52. In this case, as the response consists of John's salary, access control manager determines that this response is authorized for return to servlet 52 as there are no access controls on the return of this kind of information to an outside party. As such, access control manager 64 provides a positive response to EJB proxy 64 which, in turn, provides John's salary to servlet 52.

Upon provision of John's salary to servlet 52, the method is completed. Servlet 52 then delegates the appropriate information to a JSP for generation of an HTML page displaying John's salary for transmission back to client machine 28.

When John wishes to look up the salary of Dave, an employee in another department, the process followed is the same as in the previous example for steps 210 to 234. At step 235, however, policy manager 100 queries database 104 and determines that John does not have the right to access Dave's EmployeeRecord entity bean. As John does not satisfy the relevant access rules and access rights, policy manager 100 determines that the call is not authorized.

At step 236, policy manager 100 returns a negative response to access control manager 64 that, in turn, provides a negative response to EJB proxy 60. As such, at step 270, EJB proxy 60 generates an exception and returns it to servlet 52. Servlet 52, in turn, directs a JSP to generate a page that indicates that the request is not authorized.

When Mike wishes to modify Ed's salary, the process is similar to the case where John wishes to view his own salary, with certain variations. As the kind of access is different than in the previous example, at step 232, access control manager obtains a different set of rules from supplementary access control rules 68. In this case, access control manager 64 is provided with the following criterion which must be satisfied for this call to be authorized: the logged-in user is able to access Ed's EmployeeRecord entity bean with the role of “administrator”. At step 235, policy manager 100 queries database 104 and determines that Mike can access Ed's EmployeeRecord entity bean with the role of “administrator”. As such, the first access criteria for the updateSalary ( EmployeeRecord, xxxxx ) business method are met and policy manager 100 determines that the call is authorized. At step 260, EJB proxy 60 provides servlet 52 the ability to modify Ed's extension.

When Mike wishes to modify the salary of Dave, an employee in another department, at step 235, policy manager 100 determines that Mike can not access Dave's EmployeeRecord entity bean and, as a result, returns a negative response to access control manager 64 that, in turn, responds negatively to EJB proxy 60. EJB proxy 60 generates a negative response, in this case by throwing an exception, and provides it to servlet 52 at step 270.

While the above embodiment describes the generation of a set of Java classes that capture the rules set out in the security deployment descriptor, there are other methods by which entity-based security specified in the security deployment descriptor can be enforced.

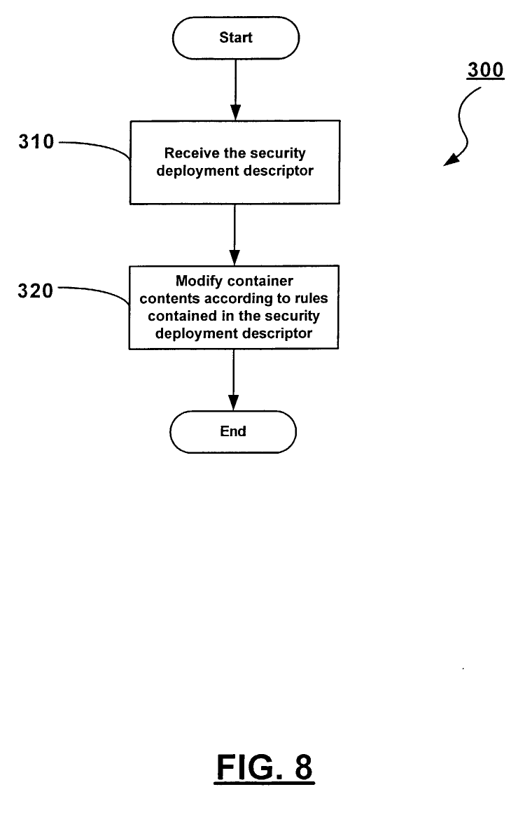

A method of using security deployment descriptor 72 in accordance with another embodiment of the invention is shown at 300 in FIG. 8. In the present embodiment, a set of security rules are received at step 310.

The security deployment descriptor is an XML file similar to a standard deployment descriptor in that each contains a set of rules for controlling access to EJBs and to methods thereof. While a container's deployment descriptor provides, among other things, a set of access control rules, the container's deployment descriptor does not allow for entity-based security and access control functionality is handled by the container itself, in accordance with the EJB 2.0 Specifications.

The security deployment descriptor, on the other hand, allows for the declarative specification of a set of access control rules that are at least partially entity-based for a set of EJBs contained in the EJB container. This is achieved by a set of tags similar to those employed to provide role-based security capabilities to the deployment descriptor of a EJB container. In a particular embodiment, the authorization criteria are positively declared and are selected from a combination of entity-based and role-based constraints. That is, the authorization criteria to be met are stated in terms of the criteria for authorized groups. It will be apparent, however, to those of skill in the art that a number of methods can be employed to declare the authorization rules.

At step 320, the container contents are modified to enable entity-based security. In an embodiment, the security deployment descriptor is parsed and the role-based security rules contained therein are converted to a set of Java classes that enables the container to manage the entity-based security. Currently, during the initialization of an EJB container, the container's deployment descriptor is read and a set of Java classes are constructed therefrom. This set of Java classes, known as the security policy, is then referred to by the container during execution to determine what role-based access controls are to be enforced for a specific call to an EJB. This embodiment involves the modification of the Java container such that it is able to enforce the at least partially entity-based security rules, much in the same manner in which it currently is able to enforce role-based security rules.

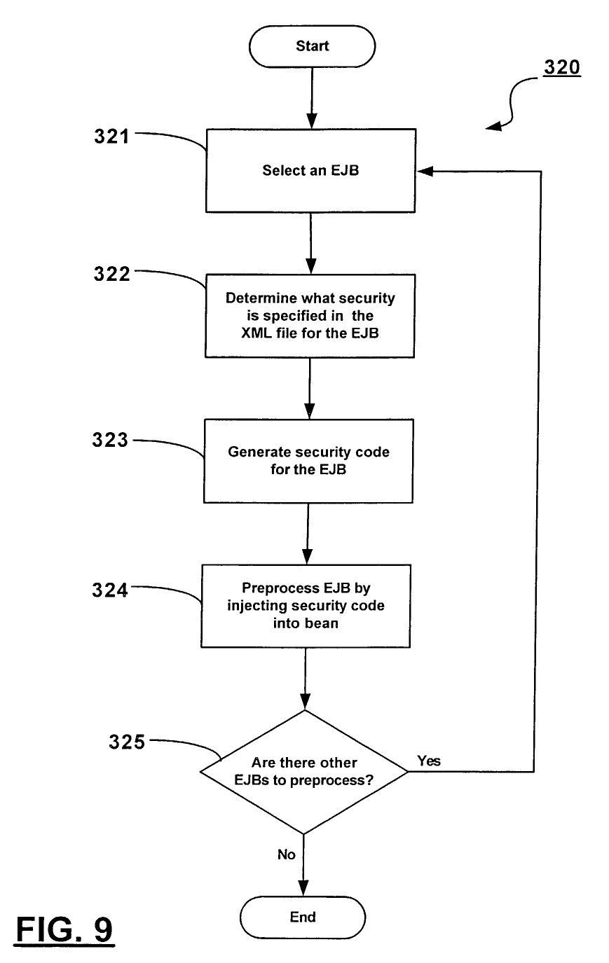

FIG. 9 shows another embodiment of the method of modifying the container contents according to rules contained in the security deployment descriptor. At step 321, prior to deployment of the container, an EJB is selected from the EJBs to be deployed in the container that have not yet been preprocessed according to this method.

At step 322, the security deployment descriptor is then parsed to determine what access controls have been specified for the EJB.

At step 323, Java security code is generated for the set of access control rules specified by the security deployment descriptor.

At step 324, the bean is preprocessed prior to deployment by injecting the Java security code generated at step 323 such that, upon deployment, the bean will be able to enforce its own security.

At step 325, it is determined whether there remain any EJBs for which these operations have not been carried out. Upon the completion of these operations for each EJB to be deployed in the container, the method terminates.

It is to be understood by those of skill in the art that the method of this embodiment can be performed as part of the deployment operation or separately prior to the deployment operation.

While the embodiments discussed herein are directed to specific implementations of the invention, it will be understood that combinations, sub-sets and variations of the embodiments are within the scope of the invention. For example, the security rules contained in the security deployment descriptor can be placed in the container's deployment descriptor.

It is contemplated that all security could be enforced after the call is made but prior to providing the response to the client.

While, for purposes of illustration, the servlet acts as a client, it is understood by those of skill in the art that other applications can be substituted.

While the embodiments presented herein have been described with particularity to Java, it is understood by those of skill in the art that the invention can apply to other programming environments.

The above-described embodiments of the invention are intended to be examples of the present invention and alterations and modifications may be effected thereto, by those of skill in the art, without departing from the scope of the invention which is defined solely by the claims appended hereto.

[image]

[image]

[image]

[image]

We claim:

1. A method of providing entity-based security in a computer system, comprising the steps of:
receiving a request to access at least one of a plurality of server objects on a server;
determining whether said request is authorized based on a set of access control rules that are respective to an entity represented by said at least one server object;
permitting said request if said request is authorized at said determining step; and,
rejecting said request if said request is not authorized at said determining step.

2. The method according to claim 1, wherein said set of access control rules are configured in a configuration file.

3. The method according to claim 1, wherein said set of access control rules are encoded in an XML file.

4. The method according to claim 1, wherein said server is executing Java Enterprise Edition.

5. The method according to claim 1, wherein a set of roles are defined for each of said entities, and said access control rules reflect access rights corresponding to each of said roles.

6. The method according to claim 1 wherein said roles include an administrator, a viewer and an owner.

7. The method according to claim 1 where said access rights include a right to perform at least one of creating, removing, updating, deleting and viewing said one server object.

8. The method according to claim 1 wherein said set of access control rules are codified in a set of Java classes.

9. The method according to claim 1, wherein said entity is represented as an entity bean.

10. The method according to claim 1, wherein said request is for a method associated with said server object.

11. The method according to claim 1, wherein said request is for an attribute associated with said server object.

12. A method of initiating a container in a J2EE server;
reading an XML security deployment descriptor file containing a set of access control rules;
generating a set of supplementary access control rules from said access control rules; and,
generating an access control manager for utilizing said set of supplementary access control rules to selectively authorize or reject access requests to an object representing an entity.

13. A system for entity-based security comprising:
a server having a central processing unit (CPU), a data storage device for exchanging non-volatile data with said CPU, random access memory (RAM) for exchanging volatile data with said CPU, and an input device for receiving data for said CPU and output device for presenting outputted data from said CPU;
said CPU operable to receive, via said input device, a request to access one of a plurality of server objects stored in said data storage device, each of said server objects representing an entity;
said CPU further operable to authorize or reject said request based on a set of access control rules that are respective to each of said entities; and,
said CPU further operable to present said authorization or rejection to said output device.

14. The system according to claim 13 wherein said input device is a keyboard connected to said server and said output device is a monitor connected to said server.

15. The system according to claim 13 wherein said input device and said output device are combined in a network interface card (NIC) that is connectable to a client machine.

16. The system according to claim 13 wherein said set of access control rules are configured in a configuration file.

17. The system according to claim 13 wherein said set of access control rules are encoded in an XML file.

18. The system according to claim 13 wherein said CPU is executing Java Enterprise Edition.

19. The system according to claim 13 wherein a set of roles are defined for each of said entities, and said access control rules reflect access rights corresponding to each of said roles.

20. The system according to claim 13 wherein said roles include an administrator, a viewer and an owner.

21. The system according to claim 13 wherein said access rules reflect a right to perform at least one of creating, removing, updating, deleting and viewing said one server object.

22. The system according to claim 13 wherein said set of access control rules are codified in a set of Java classes.

23. The system according to claim 13 wherein said entity is represented as an entity bean.

24. The system according to claim 13 wherein said request is for a method associated with said server object.

25. The system according to claim 13 wherein said request is for an attribute associated with said server object.

26. A system for providing entity-based security, comprising:
a server providing a set of application functionality providing access to a number of sets of data representing a number of objects;
a process executing on said server that is operable to determine whether an access request that is directed at one of said number of sets of data corresponding to one of said number of objects is authorized based on a set of access control rules.

27. The system according to claim 26 wherein said set of access control rules are configured in an XML file.

28. The system according to claim 26 wherein said XML file is used to generate an access control rules object from which said server process obtains said set of access control rules.

29. The system according to claim 26 wherein said server executes Java Enterprise Edition.

30. The system according to claim 26 wherein said number of sets of data are represented by a number of entity beans.

31. The system for providing entity-based security of claim 26, additionally comprising:
a database storing a set of user access rights for said number of sets of data.

32. The system according to claim 26 wherein said process is a proxy.

33. A method of providing entity-based security in a computer system, comprising the steps:
configuring in a configuration file a set of rules for controlling access to a set of data objects;
generating a set of access control code for one of said set of data objects based on said set of rules;
injecting said set of access control code into said one of said set of data objects.

34. The method according to claim 33 wherein the configuration file is written in XML.

35. The method according to claim 33 wherein each of said set of data objects is represented by an entity bean.

36. The method according to claim 33 wherein said set of rules provide access control for a number of aspects of said set of data objects.
